(19) United States
(12) Patent Application Publication
(10) Pub. No.: US 2023/0209593 A1
(43) Pub. Date: Jun. 29, 2023

(54) METHODS FOR COMMUNICATIONS, TERMINAL DEVICE, AND COMPUTER READABLE MEDIA

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 17/927,205

(22) PCT Filed: Jul. 10, 2020
(86) PCT No.: PCT/CN2020/101410

§ 371 Date: Nov. 22, 2022

(51) Int. Cl. H04W 74/08

(52) U.S. Cl. CPC H04W 74/0808; H04W 92/18

(57) ABSTRACT

Embodiments of the present disclosure provide a solution for partial sensing of sidelink channels. A method for communications comprises determining, at a first terminal device, a second resource in a resource selection window based on a first resource in a sensing window and a resource reservation period for a second terminal device. The method also comprises selecting, from the resource selection window, a resource as a candidate resource for a second sidelink transmission of the first terminal device by performing partial sensing of sidelink channels in the sensing window. The candidate resource is different from the second resource.

### FIELD

Embodiments of the present disclosure generally relate to the field of communication, and in particular, to a solution for partial sensing of sidelink channels.

### BACKGROUND

Certain communication systems enable vehicle to everything (V2X) and device to device (D2D) communications to be performed. V2X communications can be based on communication technologies such as sidelink communication technologies. For this, sidelink resource pools and sidelink channels can be established for vehicles participating in such communications.

In V2X communications, there are two modes of resource allocation. In a first mode (also referred to as NR V2X mode 1 or mode 1 hereinafter), a terminal device may perform V2X communications with another terminal device by using resources allocated by a network device. In a second mode (also referred to as NR V2X mode 2 or mode 2 hereinafter), a terminal device may perform V2X communications with another terminal device by using resources autonomously selected in a resource selection window by the terminal device. In mode 2, a terminal device may select resources in the resource selection window by performing sensing of sidelink channels, partial sensing of the sidelink channels, or random selection of the resources.

In the case of sensing, the terminal device may select all the potential candidate resources in the resource selection window. Then, the terminal device may determine whether all the potential candidate resources are occupied by other terminal devices by performing sensing. In the case of partial sensing, the terminal device may select part of all the potential candidate resources in the resource selection window. In turn, the terminal device may determine whether the selected potential candidate resources are occupied by other terminal devices by performing partial sensing. In the case of random selection, the terminal device will not determine whether the potential candidate resources are occupied by other terminal devices by performing sensing or partial sensing. Instead, the terminal device may consider all the potential candidate resources may be used as candidate resources for a sidelink transmission. Enhancement for partial sensing for NR V2X needs to be studied.

### SUMMARY

In general, example embodiments of the present disclosure provide a solution for partial sensing of sidelink channels.

In a first aspect, there is provided a method for communications. The method comprises obtaining, at a terminal device, the predetermined number of potential candidate resources in a resource selection window for a sidelink transmission. The predetermined number is selected from a plurality of sets of values. The plurality of sets of values are associated with different minimum sizes of the resource selection window. The method also comprises selecting a first number of the potential candidate resources from the resource selection window for performing partial sensing of sidelink channels. The first number is above the predetermined number.

In a second aspect, there is provided a method for communications. The method comprises obtaining, at a terminal device, the predetermined number of potential candidate resources in a resource selection window for a sidelink transmission. The predetermined number is associated with a parameter for determining an end of the resource selection window. The parameter is dedicated for partial sensing of sidelink channels. The method also comprises selecting a first number of the potential candidate resources from the resource selection window for performing the partial sensing. The first number is above the predetermined number.

In a third aspect, there is provided a method for communications. The method comprises determining, at a first terminal device, a second resource in a resource selection window based on a first resource in a sensing window and a resource reservation period for a second terminal device. The method also comprises selecting, from the resource selection window, a resource as a candidate resource for a second sidelink transmission of the first terminal device by performing partial sensing of sidelink channels in the sensing window. The candidate resource is different from the second resource.

In a fourth aspect, there is provided a terminal device. The terminal device comprises a processor and a memory storing instructions. The memory and the instructions are configured, with the processor, to cause the terminal device to perform the method according to the first aspect.

In a fifth aspect, there is provided a terminal device. The terminal device comprises a processor and a memory storing instructions. The memory and the instructions are configured, with the processor, to cause the terminal device to perform the method according to the second aspect.

In a sixth aspect, there is provided a terminal device. The terminal device comprises a processor and a memory storing instructions. The memory and the instructions are configured, with the processor, to cause the terminal device to perform the method according to the third aspect.

In a seventh aspect, there is provided a computer readable medium having instructions stored thereon. The instructions, when executed on at least one processor of a device, cause the device to perform the method according to the first aspect.

In an eighth aspect, there is provided a computer readable medium having instructions stored thereon. The instructions, when executed on at least one processor of a device, cause the device to perform the method according to the second aspect.

In a ninth aspect, there is provided a computer readable medium having instructions stored thereon. The instructions, when executed on at least one processor of a device, cause the device to perform the method according to the third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 illustrates a flowchart of an example method in accordance with some embodiments of the present disclosure;

FIG. 3 illustrates a flowchart of another example method in accordance with some embodiments of the present disclosure;

FIG. 4 illustrates a flowchart of yet another example method in accordance with some embodiments of the present disclosure;

FIG. 5 illustrates an example of a periodic resource reservation in accordance with some embodiments of the present disclosure; and

FIG. 6 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X communication, a Transmission/Reception Point (TRP), a Remote Radio Unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), vehicle-mounted terminal devices, devices of pedestrians, roadside units, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, some embodiments will be described with reference to UEs as examples of terminal devices and the terms “terminal device” and “user equipment” (UE) may be used interchangeably in the context of the present disclosure.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As indicated, partial sensing procedures for sidelink transmissions are not specified in the 5G NR, especially for configurable reservation periods and aperiodic traffic reservations. In particular, NR sidelink enhancement may include resource allocation enhancement to specify resource allocation to reduce power consumption of the UEs. sidelink random resource selection and partial sensing to NR sidelink resource allocation mode 2 may be considered. It is noted that introducing a new solution to reduce power consumption for the cases where above methods cannot work properly.

As described above, in the case of partial sensing, the terminal device may select part of all the potential candidate resources in the resource selection window. In turn, the terminal device may determine whether the selected potential candidate resources are occupied by other terminal devices by performing partial sensing.

In a first conventional solution for Long Term Evolution (LTE) V2X, the terminal device shall determine by its implementation a set of subframes which consists of at least Y subframes within a time interval [n+T₁,n+T₂], where selections of T₁ and T₂ are up to implementations of the terminal device under T₁≤4 and 20≤T₂≤100. The selection of T₂ shall fulfil the latency requirement and Y shall be greater than or equal to a higher layer parameter minNumCandidateSF. The higher layer parameter minNumCandidateSF indicates the minimum number of subframes that are included in the possible candidate resources. The higher layer parameter minNumCandidateSF is in the range [1, 13]. In other words, minNumcandidateSF is selected from a single set of values [1 . . . 13].

For any candidate resource in subframe n within the set of Y subframes, the terminal device senses at least subframe n−100*k. The set of k is configured or preconfigured with each element in the range [1, 10].

In view of the above, in the first conventional solution, the minimum size of the resource selection window has a single value, that is [n+4, n+20], which contains 17 subframes. Thus, it is feasible and reasonable to select Y subframes >=minNumcandidateSF::{1 . . . 13} according to the implementation of the terminal device.

In a second conventional solution for NR V2X, a candidate single-slot resource for transmission R_{x,y} is defined as a set of L_{subCH} contiguous sub-channels with sub-channel x+j in slot t_{y}^{SL} where j=0, . . . , L_{subCH}−1. The terminal device shall assume that any set of L_{subCH} contiguous sub-channels included in the corresponding resource pool within the time interval [n+T₁, n+T₂] correspond to one candidate single-slot resource. The selection of T₁ is up to UE implementation under 0≤T₁≤T_{proc,1}^{SL}, where T_{proc,1}^{SL} depends on μ and is defined in slots in Table 1, and μ is the subcarrier spacing (SCS) configuration of the sidelink bandwidth part (BWP) for the terminal device.

TABLE 1

| μ | T_{proc, 1}^{SL} |
|---|---|
| 0 | 3 |
| 1 | 5 |
| 2 | 9 |
| 3 | 17 |

If T₂ₘᵢₙ is shorter than the remaining packet delay budget (RPDB, in slots), T₂ is up to implementation of the terminal device subject to T₂ₘᵢₙ≤T₂≤RPDB; otherwise T₂ is set to the RPDB (in slots). The mapping among μ, T₁, T₂ₘᵢₙ, and RPDB are shown in Table 2.

TABLE 2

T_{2 min} ≤ T₂ ≤ RPDB

| μ | T₁ | T_{2 min} | RPDB |
|---|---|---|---|
| 0 | [0 . . . 3] | 1, 5, 10, 20 | RPDB |
| 1 | [0 . . . 5] | 2, 10, 20, 40 | RPDB |
| 2 | [0 . . . 9] | 4, 20, 40, 80 | RPDB |
| 3 | [0 . . . 17] | 8, 40, 80, 160 | RPDB |

In the second conventional solution, T₂ₘᵢₙ, is set to the corresponding value from a higher layer parameter sl-Selection Window-r16. In addition, T₂ₘᵢₙ is (pre-)configured per priority indicated in SCI from the following set of values: {1, 5, 10, 20}*2^{μ}, where μ=0,1,2,3 for SCS 15, 30, 60, 120 respectively. The higher layer parameter sl-Selection Window-r16 may be any of n1, n5, n10 and n20.

In view of the above, in the second conventional solution, the resource selection window [n+T₁,n+T₂] may have different minimum sizes depending on μ, T₂ₘᵢₙ, RPDB and implementation of the terminal device.

Specifically, if μ=0 and RPDB>=T₂ₘᵢₙ, the minimum size of the resource selection window will be 1, 3, 8, 18; if μ=0 and RPDB<T₂ₘᵢₙ, the minimum size of the resource selection window will be RPDB−3+1 or 1.

If μ=1 and RPDB>=T₂ₘᵢₙ, the minimum size of the resource selection window will be 1, 6, 16, 36; if μ=1 and RPDB<T₂ₘᵢₙ, the minimum size of the resource selection window will be RPDB−5+1 or 1.

If μ=2 and RPDB>=T₂ₘᵢₙ, the minimum size of the resource selection window will be 1, 12, 32, 72; if μ=2 and RPDB<T₂ₘᵢₙ, the minimum size of the resource selection window will be RPDB−9+1 or 1.

If μ=3 and RPDB>=T₂ₘᵢₙ, the minimum size of the resource selection window will be 1, 24, 64, 144; if μ=3 and RPDB<T₂ₘᵢₙ, the minimum size of the resource selection window will be RPDB−17+1 or 1.

Because the resource selection window [n+T₁, n+T₂] may have different minimum sizes and the resource selection window may contain only one slot, selecting the minNumcandidateSF from a single set of values is not suitable for the second conventional solution.

In order to solve the above technical problems in conventional solutions, embodiments of the present disclosure provide a solution for determining potential candidate resources. In this solution, different minimum sizes of a resource selection window are associated with a plurality of sets of values. The predetermined number of potential candidate resources in a resource selection window is selected from the plurality of sets of values. A terminal device selects a first number of the potential candidate resources from the resource selection window for performing partial sensing of sidelink channels. The first number is above the predetermined number. With this solution, enhancement for partial sensing for NR V2X is achieved.

Moreover, in the first conventional solution, the reported sensing result may be inaccuracy due to “unknown” slots. Specifically, for a slot n, a monitoring slot associated with the slot n is m. In some cases, the terminal device may have not monitored slot m. For example, if the terminal device performs a sidelink transmission in the slot m, the terminal device will not monitor the slot m. Thus, the terminal device can not receive sidelink control information (SCI) transmitted by other terminal devices in the slot m. therefore, the terminal device can not determine whether the slot n is reserved by other terminal devices for their sidelink transmission. In this case, the slot n may be referred to as an unknown slot. The reported sensing result comprising the unknown slot may be inaccuracy. Thus, the sidelink transmission of the terminal device will not be influenced by other terminal devices.

In order to solve the above technical problems in conventional solutions, embodiments of the present disclosure provide a solution for determining candidate resources. In this solution, if a terminal device has not monitor a first resource in a sensing window, the terminal device will exclude a second resource associated with the first resource from a resource selection window. In turn, the terminal device selects, by performing partial sensing of sidelink channels in the sensing window, at least one resource from the resource selection window as at least one candidate resource for performing a sidelink transmission by the terminal device. In this way, the sensing result will not comprise any unknown slot and thus the sensing result will be accuracy.

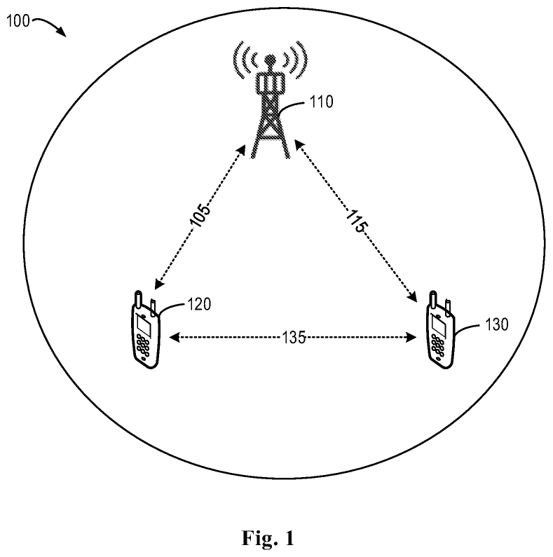

FIG. 1 is a schematic diagram of a communication environment 100 in which some embodiments of the present disclosure can be implemented. As shown in FIG. 1, the communication environment 100, which may also be referred to as a communication network 100, includes a network device 110 serving a first terminal device 120 and a second terminal device 130. In particular, the first terminal device 120 may communicate with the network device 110 via a communication channel 105, and the second terminal device 130 may communicate with the network device 110 via a communication channel 115.

For transmissions from the network device 110 to the first terminal device 120 or the second terminal device 130, the communication channel 105 or 115 may be referred to as a downlink channel, whereas for transmissions from the first terminal device 120 or the second terminal device 130 to the network device 110, the communication channel 105 or 115. In the following, the first terminal device 120 and the second terminal device 130 can also be referred to as the terminal device 120 and the terminal device 130 for simplicity.

Additionally, the first terminal device 120 may communicate with the second terminal device 130 via a device-to-device (D2D) channel 135, which may also be referred to as a sidelink channel 135. In some cases, the network device 110 may be absent in the communication environment 100. For example, one or more of the first terminal device 120, the second terminal device 130 and other terminal devices (not shown) may be out of the coverage of the network device 110. In such cases, only sidelink communications exist between the first terminal device 120 and the second terminal device 130 as well as possibly other terminal devices not shown in FIG. 1.

In some embodiments, during a sidelink communication between the first terminal device 120 and the second terminal device 130 via the sidelink channel 135, the first terminal device 120 can perform a sidelink transmission to the second terminal device 130 using a set of transmission resources. As used herein, the term “sidelink transmission” generally refers to any transmission performed from one terminal device to another terminal device via a sidelink channel between them. The sidelink transmission may be used for transmitting any data or control information associated with sidelink communications, for example, sidelink data or sidelink control information (SCI) or sidelink feedback information. As used herein, the term “sidelink channel” may generally refer to any channels for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

As used herein, the term “resource,” “transmission resource,” or “sidelink resource” may refer to any resource for performing a communication, for example, a sidelink communication between terminal devices, such as a resource in time domain (for example, a time slot), a resource in frequency domain (for example, a sub-channel), a resource in space domain, a resource in code domain, or any other resource enabling a communication, and the like. In the following, a resource in both frequency domain and time domain may be used as an example of a sidelink resource for describing some embodiments of the present disclosure. However, it is noted that embodiments of the present disclosure are equally applicable to any other resources in any other domains.

Although the network device 110, the first terminal device 120 and the second terminal device 130 are described in the communication environment 100 of FIG. 1, embodiments of the present disclosure may be equally applicable to any other suitable communication devices in communication with one another. That is, embodiments of the present disclosure are not limited to the example scenario of FIG. 1. In this regard, it is noted that although the first and second terminal devices 120 and 130 are schematically depicted as mobile phones in FIG. 1, it is understood that this depiction is only for example without suggesting any limitation. In other embodiments, the first and second terminal devices 120 and 130 may be any other wireless communication devices, for example, vehicle-mounted terminal devices.

In the case where the first and second terminal devices 120 and 130 are vehicle-mounted terminal devices, the communications related to them may be referred to as V2X communications. More generally, although not shown in FIG. 1, a V2X communication related to the first and second terminal devices 120 and 130 may comprise a communication between the first or second terminal devices 120 or 130 and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the number of the terminal devices and the number of the network devices as shown in FIG. 1 are only for the purpose of illustration without suggesting any limitations. The communication environment 100 may include any suitable number of terminal devices, any suitable number of network devices, and any suitable number of other communication devices adapted for implementing embodiments of the present disclosure. In addition, it would be appreciated that there may be various wireless communications as well as wireline communications (if needed) among all the communication devices.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

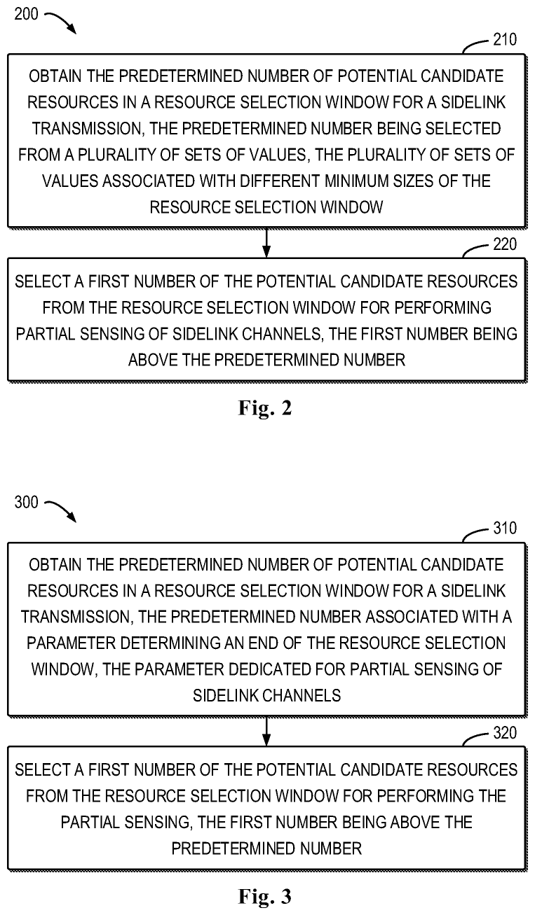

FIG. 2 illustrates a flowchart of an example method 200 in accordance with some embodiments of the present disclosure. In some embodiments, the method 200 can be implemented at a terminal device, such as the first terminal device 120 as shown in FIG. 1. Additionally or alternatively, the method 200 can also be implemented at the second terminal device 130 or other terminal devices not shown in FIG. 1. For the purpose of discussion, the method 200 will be described with reference to FIG. 1 as performed by the terminal device 120 without loss of generality.

At block 210, the terminal device 120 obtains the predetermined number of potential candidate resources in a resource selection window for a sidelink transmission. The predetermined number is selected from a plurality of sets of values. The plurality of sets of values are associated with different minimum sizes of the resource selection window.

In some embodiments, a physical layer of the terminal device 120 may obtain the predetermined number from a higher layer of the terminal device 120. Examples of the higher layer may include, but are not limited to a media access control (MAC) layer and radio resource control (RRC) layer.

In some embodiments, the predetermined number of potential candidate resources may indicate the minimum number of the potential candidate resources. Because the minimum number is selected from the plurality of sets of values associated with different minimum sizes of the resource selection window, the proper minimum number of allowed candidate resources for NR V2X partial sensing can be configured.

In some embodiments, each set of the values are determined based on at least one of the following: a SCS configuration for the terminal device 120, a parameter for determining an end of the resource selection window, or a RPDB for the sidelink transmission. In some embodiments, the parameter for determining an end of the resource selection window may be represented by the higher layer parameter sl-Selection Window-r16 or T₂ₘᵢₙ as described above.

In some embodiments, the plurality of sets of values may comprise {[1], [1 . . . N1*2\hat{ }μ], [1 . . . N2*2\hat{ }μ], [1 . . . N3*2\hat{ }μ]} where μ=0, 1, 2, 3 for SCS 15, 30, 60, 120 KHz respectively. For example, as described above, in the case where μ=0 and RPDB>=T₂ₘᵢₙ, the minimum size of the resource selection window will be 1, 3, 8, 18. In this case, N1=3, N2=8, N3=18. For another example, as described above, in the case where μ=1 and RPDB>=T₂ₘᵢₙ, the minimum size of the resource selection window will be 1, 6, 16, 36. In this case, N1=6, N2=16, N3=36.

In other embodiments, the plurality of sets of values may comprise {[1 . . . N1*2\hat{ }μ], [1 . . . N2*2\hat{ }μ], [1 . . . N3*2\hat{ }μ]} where μ=0, 1, 2, 3 for SCS 15, 30, 60, 120 KHz respectively. In some embodiments, N1=3, N2=8, N3=18.

In still other embodiments, the plurality of sets of values may comprise {[1], [1 . . . N1], [1 . . . N2], [1 . . . N3]} where the values are determined with a reference SCS 15 KHz. In some embodiments, N1=3, N2=8, N3=18.

In yet other embodiments, the plurality of sets of values may comprise {[1 . . . N1], [1 . . . N2], [1 . . . N3]} where the values are determined with the reference SCS 15 KHz. In some embodiments, N1=3, N2=8, N3=18.

It should be appreciated that the values of N1, N2 and N3 are described by way of example. Depending on a specific scenario, N1, N2 and N3 may take any other appropriate values.

In some embodiments, the terminal device 120 may obtain the predetermined number via the following parameter: ASN.1 parameter could be minNumCandidateSl::=INTEGER (ENUMERATED {1, 1 . . . M1, 1 . . . M2, 1 . . . M3}) where minNumCandidateSl represents the predetermined number, M1=N1 or N1*2\hat{ }μ, M2=N2 or N2*2\hat{ }μ, and M3=N3 or

In some embodiments, the predetermined number is selected from a first set of the plurality of sets, and the first set is selected from the plurality of sets based on a priority of data to be transmitted by the terminal device 120. The selection of the first set may depend on implementation of the terminal device 120. In some embodiments, in the case where the higher the priority, a set having a greater range of values may be selected as the first set. For example, if μ=0, N1=3, N2=8, and N3=18, the sets [1 . . . N2*2\hat{ }μ] and [1 . . . N3*2\hat{ }μ] have greater ranges of values than the set [1 . . . N1*2\hat{ }μ]. Thus, one of the sets [1 . . . N2*2\hat{ }μ] and [1 . . . N3*2\hat{ }μ] may be selected as the first set.

In the embodiments where the plurality of sets of values may comprise {[1], [1 . . . N1], [1 . . . N2], [1 . . . N3]} or {[1 . . . N1], [1 . . . N2], [1 . . . N3]}, because the values are determined based on the reference SCS 15 KHz, upon obtaining the predetermined number, the terminal device 120 may update the predetermined number with a product of the predetermined number and a predetermined value. The predetermined value is associated with a SCS configuration for the terminal device 120. For example, the terminal device 120 may update the predetermined number based on the following:

minNumCandidateSl=minNumCandidateSl*2\hat{ }μ (1)

where minNumCandidateSl represents the predetermined number, μ=0, 1, 2, 3 for SCS=15, 30, 60, 120 KHz respectively.

Because the predetermined number may be updated according to different SCS configurations, the method according to the present disclosure may be feasible for different SCS.

In the embodiments where the plurality of sets of values may comprise {[1], [1 . . . N1], [1 . . . N2], [1 . . . N3]} or {[1 . . . N1], [1 . . . N2], [1 . . . N3]}, the terminal device 120 may determine whether minNumCandidateSl is the same as a predetermined value (hereinafter also referred to as a first predetermined value). If minNumCandidateSl is different from the first predetermined value, the terminal device 120 may update the predetermined number with the product. In some embodiments, the first predetermined value may be one. In other embodiments, the first predetermined value may be any appropriate value.

In some embodiments, the terminal device 120 may obtain the predetermined number in association with the parameter for determining the end of the resource selection window.

In some embodiments, the terminal device 120 may obtain the predetermined number minNumCandidateSl in association with the parameter sl-SlectionWindow-r16 via an RRC parameter SlectionWindowAndMinNumCandidateSl.

In some embodiments, an example ASN.1 for the parameter SlectionWindowAndMinNumCandidateSl may be as follows.

| SlectionWindowAndMinNumCandidateSl::= | CHOICE{ |
|---|---|
| Pattern 1 | SEQUENCE { |
| sl-SlectionWindow-r16 | ENUMERATED {n1}, |
| minNumCandidateSl | INTEGER (1) |
| }, | |
| Pattern 2 | SEQUENCE { |
| sl-SlectionWindow-r16 | ENUMERATED {n5}, |
| minNumCandidateSl | INTEGER (1...3) |
| }, | |
| Pattern 3 | SEQUENCE { |
| sl-SlectionWindow-r16 | ENUMERATED {n10}, |
| minNumCandidateSl | INTEGER (1...8) |
| }, | |
| Pattern 4 | SEQUENCE { |
| sl-SlectionWindow-r16 | ENUMERATED {n20}, |
| minNumCandidateSl | INTEGER (1...18) |

},
...
}

In some other embodiments, another example ASN.1 for the parameter SlectionWindowAndMinNumCandidateSl may be as follows.

| SlectionWindowAndMinNumCandidateSl::= | CHOICE{ |
|---|---|
| Pattern 1 | SEQUENCE { |
| sl-SlectionWindow-r16 | ENUMERATED {n5}, |
| minNumCandidateSl | INTEGER (1...3) |
| }, | |
| Pattern 2 | SEQUENCE { |
| sl-SlectionWindow-r16 | ENUMERATED {n10}, |
| minNumCandidateSl | INTEGER (1...8) |
| }, | |
| Pattern 3 | SEQUENCE { |
| sl-SlectionWindow-r16 | ENUMERATED {n20}, |
| minNumCandidateSl | INTEGER (1...18) |

},
...
}

In some embodiments, n1, n5, n10 and n20 may be 1, 5, 10, 20 based on a reference SCS (15 KHz) respectively. In other embodiments, n1, n5, n10 and n20 may take any appropriate value.

In the embodiments where the predetermined number is obtained in association with the parameter for determining the end of the resource selection window, the terminal device 120 may determine whether sl-SlectionWindow-r16 is the same as a predetermined value (hereinafter also referred to as a second predetermined value). If sl-SlectionWindow-r16 is different from the second predetermined value, the terminal device 120 may update the predetermined number with the product. In some embodiments, the second predetermined value may be n1. In other embodiments, the second predetermined value may be any appropriate value.

In the embodiments where the predetermined number is obtained in association with the parameter for determining the end of the resource selection window, the terminal device 120 may determine whether minNumCandidateSl is the same as the first predetermined value. If minNumCandidateSl is different from the first predetermined value, the terminal device 120 may update the predetermined number with the product.

FIG. 3 illustrates a flowchart of an example method 300 in accordance with some embodiments of the present disclosure. In some embodiments, the method 300 can be implemented at a terminal device, such as the first terminal device 120 as shown in FIG. 1. Additionally or alternatively, the method 300 can also be implemented at the second terminal device 130 or other terminal devices not shown in FIG. 1. For the purpose of discussion, the method 300 will be described with reference to FIG. 1 as performed by the terminal device 120 without loss of generality.

At block 310, the terminal device 120 obtains the predetermined number of potential candidate resources in a resource selection window for a sidelink transmission. The predetermined number is associated with a parameter for determining an end of the resource selection window. The parameter is dedicated for partial sensing of sidelink channels. That is, the parameter takes a fixed value for the partial sensing.

In some embodiments, the predetermined number of potential candidate resources may indicate the minimum number of the potential candidate resources.

In some embodiments, the parameter for determining an end of the resource selection window may be any of 20, 10 and 5.

In the embodiments where the parameter is 20, the mapping among and RPDB are shown in Table 3.

TABLE 3

T_{2 min} ≤ T₂ ≤ RPDB

| μ | T₁ | T_{2 min} | RPDB |
|---|---|---|---|
| 0 | [0 . . . 3] | 20 | RPDB |
| 1 | [0 . . . 5] | 40 | RPDB |
| 2 | [0 . . . 9] | 80 | RPDB |
| 3 | [0 . . . 17] | 160 | RPDB |

In Table 3, T₂ₘᵢₙ=the parameter*2\hat{ }μ.

As can be seen from Table 3, because the parameter takes a fixed value for the partial sensing, the minimum size of the resource selection window has a single value. Thus, the predetermined number may be selected from a single set of values. For example, in the case where μ=0, the minimum size of the resource selection window [n+T₁, n+T₂] may be 18. In this case, the predetermined number of potential candidate resources may be selected from a single set [1, 18].

In some embodiments, the predetermined number of potential candidate resources may be obtained via a parameter minNumCandidateSl::INTEGE(1 . . . N), where N is associated with the SCS configuration μ for the terminal device 120. For example, in the case where μ=0, N=18.

With continued reference to FIG. 3, at block 320, the terminal device 120 selects a first number of the potential candidate resources from the resource selection window for performing the partial sensing. The first number is above the predetermined number.

In some embodiments, the parameter for determining an end of the resource selection window may be determined based on the reference SCS (15 KHz). In such embodiments, upon obtaining the predetermined number of potential candidate resources, the terminal device 120 may update the predetermined number with a product of the predetermined number and a predetermined value. The predetermined value is associated with a SCS configuration for the terminal device 120. For example, the terminal device 120 may update the predetermined number based on the above equation (1).

In some embodiments, the terminal device 120 may determine whether the predetermined number is the same as the first predetermined value. If the predetermined number is different from the first predetermined value, the terminal device 120 may update the predetermined number with the product.

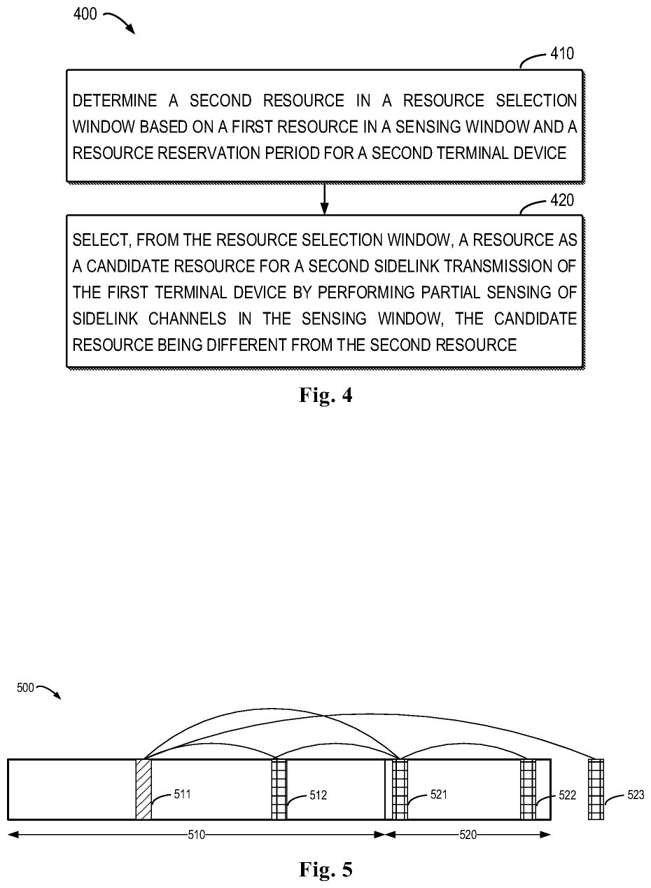

FIG. 4 illustrates a flowchart of an example method 400 in accordance with some embodiments of the present disclosure. In some embodiments, the method 400 can be implemented at a terminal device, such as the first terminal device 120 as shown in FIG. 1. Additionally or alternatively, the method 400 can also be implemented at the second terminal device 130 or other terminal devices not shown in FIG. 1. For the purpose of discussion, the method 400 will be described with reference to FIG. 1 as performed by the first terminal device 120 without loss of generality.

At block 410, the first terminal device 120 determines a second resource in a resource selection window based on a first resource in a sensing window and a resource reservation period for the second terminal device 130.

In some embodiments, information on resource reservation period for the second terminal device 130 may be included in SCI transmitted from the second terminal device 130 in the first resource. If the first terminal device 120 is transmitting data in the first resource, the first terminal device 120 can not monitor the first resource to receive the SCI transmitted from the second terminal device 130. In this case, the first terminal device 120 determines the second resource in the resource selection window based on the first resource in a sensing window and an assumed resource reservation period for the second terminal device 130. In such embodiments, the second resource may be a resource that is assumed to be reserved by the second terminal device 130.

In some embodiments, the first terminal device 120 may determine the timing of the second resource as a sum of the timing of the first resource and one or multiple resource reservation periods. In some embodiments, the resource reservation period may have a fixed value. In other embodiments, the resource reservation period may have any periodicity value allowed by a higher layer parameter reservationPeriodPartialSensing. For example, the terminal device 120 may determine the timing of the second resource based on the following:

n=m+s*reservationPeriodPartialSensing (2)

where n presents the timing of the second resource, m presents the timing of the first resource, and s presents the number of the resource reservation period and s is a natural number.

In some embodiments, the higher layer parameter reservationPeriodPartialSensing may be a subset of allowed reservation periods in the resource pool. In some embodiments, the subset may comprise {50, 100, 200, 300, . . . ,1000} ms. In other words, the resource reservation period may have any value of 50 ms, 100 ms, 200 ms, 300 ms and so on. This will be described in detail below with reference to FIG. 5.

FIG. 5 illustrates an example of a periodic resource reservation 500 in accordance with some embodiments of the present disclosure. As shown in FIG. 5, the first terminal device 120 is transmitting data in the first resource 511 in a sensing window 510.

If the first terminal device 120 assumes that the resource reservation period for the second terminal device 130 has a value of 50 ms, the first terminal device 120 may determine that a resource 512 in the sensing window 510 and resources 521 and 522 in a resource selection window 520 are reserved by the second terminal device 130. Because the resource 512 is in the sensing window 510, the resource 512 will not be considered. In this case, the timing of the resource 512 is equal to a sum of the timing of the first resource 511 and one resource reservation period (that is, s=1). The timing of the resource 521 is equal to a sum of the timing of the first resource 511 and two resource reservation periods (that is, s=2). The timing of the resource 522 is equal to a sum of the timing of the first resource 511 and three resource reservation periods (that is, s=3).

If the first terminal device 120 assumes that the resource reservation period for the second terminal device 130 has a value of 100 ms, the first terminal device 120 may determine that only the resource 521 in the resource selection window 520 is reserved by the second terminal device 130. In this case, the timing of the resource 521 is equal to a sum of the timing of the first resource 511 and one resource reservation period (that is, s=1).

If the first terminal device 120 assumes that the resource reservation period for the second terminal device 130 has a value of 200 ms, based on the above equation (2), the first terminal device 120 may determine that a resource 523 is reserved by the second terminal device 130. Because the resource 523 is not in the resource selection window 520, the resource 523 will not be considered. In this case, the timing of the resource 523 is equal to a sum of the timing of the first resource 511 and one resource reservation period (that is, s=1).

Returning to FIG. 4, at block 420, the first terminal device 120 selects, from the resource selection window, a resource as a candidate resource for a sidelink transmission of the first terminal device by performing partial sensing of sidelink channels in the sensing window. The candidate resource is different from the second resource. For example, in the example as shown in FIG. 5, the candidate resource will be different from the resources 521 and 522 in the resource selection window 520.

With the method 500, the candidate resources for the sidelink transmission of the first terminal device will not comprise any unknown slot. Thus, the sidelink transmission of the first terminal device will not be influenced by other terminal devices.

In some embodiments, the physical layer of the first terminal device 120 may select a plurality of candidate resources for the sidelink transmission by performing the method 500. Upon selecting the plurality of candidate resources, the physical layer of the first terminal device 120 may report the selected candidate resources to the higher layer of the first terminal device 120.

In some embodiments, in order to cause the candidate resource to be different from the second resource, before selecting the resource as the candidate resource, the first terminal device 120 may exclude the second resource from the resource selection window.

In some embodiments, upon receiving a higher layer parameter indicating that the excluding is enabled for the first terminal device 120, the first terminal device 120 excludes the second resource from the resource selection window.

In some embodiments, before selecting a potential candidate resource from the resource selection window as a candidate resource, the first terminal device 120 excludes the second resource from the resource selection window. In such embodiments, the first terminal device 120 may select the first number of potential candidate resources from the resource selection window. The first number is above the predetermined number. For example, the first terminal device 120 may select the first number of potential candidate resources by performing any of the methods 200 and 300. The selected potential candidate resources are different from the second resource. In other words, before selecting the first number of potential candidate resources, the first terminal device 120 excludes the second resource from the resource selection window.

Upon selecting the first number of potential candidate resources, the first terminal device 120 may determine a first subset of the first number of potential candidate resources by performing the partial sensing. In turn, the first terminal device 120 may select the resource from the first subset as the candidate resource.

In other embodiments, the first terminal device 120 may exclude the second resource from a subset of resources that are sensing results. In such embodiments, the first terminal device 120 may select a second number of potential candidate resources from the resource selection window. The second number is above a second predetermined number. For example, the second number may be equal to the first number as described with reference to FIGS. 2 and 3. Thus, the first terminal device 120 may select the second number of potential candidate resources by performing any of the methods 200 and 300.

Upon selecting the second number of potential candidate resources, the first terminal device 120 may determine a second subset of the second number of the resources by performing the partial sensing. In this case, the second subset comprises the resources that are sensing results. In turn, the first terminal device 120 may select the resource as the candidate resource from the second subset without the second resource. In other words, after excluding the second resource from the second subset, the first terminal device 120 selects the resource as the candidate resource from the second subset.

In some embodiments, in any of the methods 200, 300 and 400, a total number of the potential candidate resources in the resource selection window may be below the predetermined number of potential candidate. For example, the total number of the potential candidate resources in the resource selection window may be less than the minimum number of potential candidate resources that will be selected. This will cause failure of selecting the first number of potential candidate from the resource selection window because the first number is above the predetermined number. In such embodiments, the first terminal device 120 may provide an indication of failure of the selecting to a higher layer. Upon receiving the indication, the higher layer may adjust and reconfigure the predetermined number.

In such embodiments, the first terminal device 120 may choose not to perform partial sensing. For example, the first terminal device 120 may select all the potential candidate resources in the resource selection window to determine whether they are occupied by other terminal devices. Alternatively, the terminal device 120 will randomly select the resources from the resource selection window as candidate resources for the sidelink transmission.

In such embodiments, the first terminal device 120 may update an end of the resource selection window in such a way that the total number is above the predetermined number. For example, the first terminal device 120 may reselect a value of T2 to fulfill [n+T1, n+T2]>=minNumCandidateSl. Selection of the value of T2 should fulfill latency requirement.

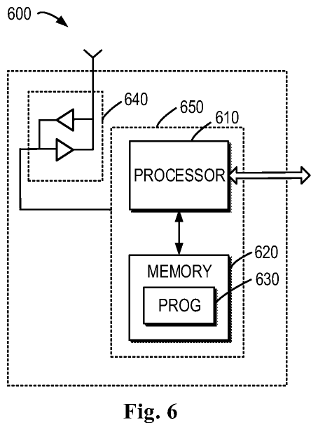

FIG. 6 is a simplified block diagram of a device 600 that is suitable for implementing some embodiments of the present disclosure. The device 600 can be considered as a further example embodiment of the first terminal device 120 and the second terminal device 130 as shown in FIG. 1. Accordingly, the device 600 can be implemented at or as at least a part of the first terminal device 120 and the second terminal device 130.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 620 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 630 is assumed to include program instructions that, when executed by the associated processor 610, enable the device 600 to operate in accordance with the embodiments of the present disclosure, as discussed herein with reference to FIGS. 2 to 4. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 12 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-14. (canceled)

15. A method performed by a terminal device, comprising:
determining a first number of resources in a resource selection window for performing partial sensing; and
determining third resources by excluding a second resource from the first number of resources based on a first resource in a sensing window and a resource reservation period,
wherein the first resource is a non-monitored resource, and the first number of resources are a subset of resources selected from the resource selection window by the terminal device based on a higher layer parameter.

16. The method of claim 15, wherein the second resource is a resource which has a time gap of integer multiple of the resource reservation period after the first resource.

17. The method of claim 15, wherein the resource reservation period has a periodicity value configured from a higher layer.

18. The method of claim 15, further comprising:
reporting the third resources to higher layer; and
performing a sidelink transmission based on the third resources.

19. The method of claim 15, wherein the first number is above a predetermined number, and the predetermined number is a minimum number of potential candidate resources for the partial sensing.

20. The method of claim 19, wherein selecting the first number of resources comprises: in accordance with a determination that a total number of the resources in the resource selection window is below the predetermined number, providing an indication of failure of the selecting to a higher layer.

21. The method of claim 20, wherein selecting the first number of resources further comprises:
selecting all resources from the resource selection window.

22. The method of claim 20, wherein selecting the first number of resources further comprises:
randomly selecting the resource from the resource selection window.

23. The method of claim 15, wherein excluding the second resource comprises:
in accordance with receiving a higher layer parameter indicating that the excluding is enabled for the terminal device, excluding the second resource.

24. A terminal device comprising a processor configured to:
determine a first number of resources in a resource selection window for performing partial sensing; and
determine third resources by excluding a second resource from the first number of resources based on a first resource in a sensing window and a resource reservation period,
wherein the first resource is a non-monitored resource, and the first number of resources are a subset of resources selected from the resource selection window by the terminal device based on a higher layer parameter.

25. A computer readable medium having instructions stored thereon, the instructions, when executed on at least one processor of a device, causing the device to:
determine a first number of resources in a resource selection window for performing partial sensing; and
determine third resources by excluding a second resource from the first number of resources based on a first resource in a sensing window and a resource reservation period,
wherein the first resource is a non-monitored resource, and the first number of resources are a subset of resources selected from the resource selection window by the terminal device based on a higher layer parameter.
